(19) United States
(12) Patent Application Publication
(10) Pub. No.: US 2025/0226961 A1
(43) Pub. Date: Jul. 10, 2025

(54) ELECTRONIC DEVICE AND CONTROL METHOD THEREFOR

(71) Applicant: SAMSUNG ELECTRONICS CO., LTD., Suwon-si (KR)

(72) Inventors: Manoj Kumar SHARMA, Suwon-si (KR); Jin SEOL, Suwon-si (KR)

(73) Assignee: SAMSUNG ELECTRONICS CO., LTD., Suwon-si (KR)

(21) Appl. No.: 19/093,711

(22) Filed: Mar. 28, 2025

Related U.S. Application Data
(63) Continuation of application No. PCT/KR2023/014227, filed on Sep. 20, 2023.

(30) Foreign Application Priority Data
Oct. 24, 2022 (KR) 10-2022-0137751

(51) Int. Cl. H04L 5/00; H04W 4/80; H04W 72/30

(52) U.S. Cl. CPC H04L 5/0094; H04L 5/0098; H04W 72/30; H04W 4/80

(57) ABSTRACT

An electronic device comprises: a memory configured to store a first audio signal and a second audio signal; a communication interface connected to a first audio device and a second audio device through a Bluetooth low energy (BLE) communication module; and at least one processor for controlling the communication interface so as to receive a first user input for multi-audio output of both the first audio signal and the second audio signal, activate a first subgroup including the first audio signal and a second subgroup including the second audio signal, provide a packet including the activated first subgroup and the activated second subgroup, and broadcast the packet, wherein the first subgroup includes first activation information indicating that the first audio signal is available for output, and the second subgroup includes second activation information indicating that the second audio signal is available for output.

### CROSS-REFERENCE TO RELATED APPLICATION

This application is a continuation application is a continuation application, under 35 U.S.C. § 111(a), of international application No. PCT/KR2023/014227, filed Sep. 23, 2023, which claims priority under 35 U. S. C. § 119 to Korean Patent Application No. 10-2022-0137751, filed Oct. 24, 2022, the disclosures of which are incorporated herein by reference in their entireties.

### TECHNICAL FIELD

The present disclosure relates to an electronic device using Bluetooth communication and a control method therefor, and more particularly, to an electronic device for transmitting multiple audio signals to a plurality of audio devices by using a Bluetooth communication module, and a control method therefor.

### BACKGROUND ART

Bluetooth low energy (BLE) communication technology is a Bluetooth technology that enables the transmission and reception of low-capacity data. Low energy (LE) audio may be an audio transmission standard using low-power Bluetooth.

A plurality of audio streams may be generated in case of using an LE audio standard. However, an interruption phenomenon may occur in a process of providing the plurality of audio streams. For example, a new transmission packet may be generated if the number of audio streams provided is changed. A user may listen to the audio streams discontinuously in a process in which a previous packet is interrupted and a new packet is transmitted.

In addition, the user may be unfamiliar with a sudden change in a usage environment in a process in which a new audio stream is provided or an existing audio stream is interrupted.

### DISCLOSURE

### Technical Solution

The present disclosure provides an electronic device for storing multiple audio signals as a separate subgroup and broadcasting the same continuously as a single packet by determining whether the subgroup is activated, and a control method therefor.

According to an embodiment of the present disclosure, an electronic device including: a memory configured to store a first audio signal and a second audio signal; a communication interface configured to connect to a first audio device and a second audio device via a Bluetooth low energy (BLE) communication module; and at least one processor configured to receive a first user input for multi-audio output that outputs the first audio signal and the second audio signal simultaneously, provide a packet that includes a first subgroup including the first audio signal and a second subgroup including the second audio signal, activated based on the received first user input, and control the communication interface to broadcast the packet, wherein the first subgroup and the second subgroup include first and second activation information indicating that the first audio signal and the second audio signal are available for output, respectively.

The user input may be a first user input and the packet may be a first packet, and the at least one processor may be configured to exclude the second subgroup deactivated based on a second user input in case of receiving the second user input for a single-audio output that outputs the first audio signal while broadcasting the first packet, modify the first packet to include only the activated first subgroup, and control the communication interface to broadcast the modified first packet.

The at least one processor may be configured to deactivate the second subgroup by executing an instruction corresponding to the deactivation of the second subgroup among a plurality of host controller interface (HCI) instructions stored in the memory.

The first packet may include advertising data, the advertising data may include information on the number of subgroups, the first subgroup, and the second subgroup, each of the first subgroup and the second subgroup may include at least one of a codec identifier (ID), codec configuration information, metadata, or the one of the first audio signal and the second audio signal, and the metadata may include the activation information indicating that the audio signal is available for output.

The first audio signal included in the first subgroup may include a first Broadcast Isochronous Stream (BIS) representing a left audio signal and a second BIS representing a right audio signal, and the second audio signal included in the second subgroup may include a third Broadcast Isochronous Stream (BIS) representing a left audio signal and a fourth BIS representing a right audio signal.

The at least one processor may be configured to provide first sync data corresponding to the first audio signal and second sync data corresponding to the second audio signal, and control the communication interface to broadcast the first audio signal, the first sync data, and the second sync data together with the first packet.

The at least one processor may be configured to provide guide information in case of receiving a second user input for a single-audio output that outputs the first audio signal while broadcasting the first packet, modify the second subgroup to include the guide information generated based on the second user input, and control the communication interface to broadcast the first packet modified to include the first subgroup and the modified second subgroup.

The guide information may include information indicating that the single-audio output is performed based on the second user input.

The at least one processor may be configured to identify a first frequency band corresponding to the first audio signal and a second frequency band corresponding to the second audio signal, and provide the first packet including the first subgroup storing the first frequency band and the second subgroup storing the second frequency band, the first frequency band being different from the second frequency band.

The device may further include a display, wherein the at least one processor is configured to control the display to display a screen including a list including at least one device available to output the first audio signal, a list including at least one device available to output the second audio signal, and the guide information requesting selection of a device to output the audio signal in case of receiving the first user input for the multi-audio output.

According to an embodiment of the present disclosure, provided is a control method for an electronic device which is connected to a first audio device and a second audio device via a Bluetooth low energy (BLE) communication module, the method including: receiving a first user input for multi-audio output that outputs a first audio signal and a second audio signal simultaneously; providing a first packet that includes a first subgroup including the first audio signal and a second subgroup including the second audio signal, activated based on the received first user input; and broadcasting the first packet, wherein the first subgroup and the second subgroup include first and second activation information indicating that the first audio signal and the second audio signal are available for output, respectively.

The method may further include: excluding the second subgroup deactivated based on a second user input if the second user input for a single-audio output that outputs the first audio signal is received while the first packet is broadcast; modifying the first packet to include only the activated first subgroup; and broadcasting the modified first packet.

In the deactivating of the second subgroup, the second subgroup may be deactivated by executing an instruction corresponding to the deactivation of the second subgroup among a plurality of host controller interface (HCI) instructions stored in the electronic device.

The first packet may include advertising data, the advertising data may include information on the number of subgroups, the first subgroup, and the second subgroup, each of the first subgroup and the second subgroup may include at least one of a codec identifier (ID), codec configuration information, metadata, or one of the first audio signal and the second audio signal, and the metadata may include the activation information indicating that the first audio signal and the second audio signal is available for output.

The first audio signal included in the first subgroup may include a first Broadcast Isochronous Stream (BIS) representing a left audio signal and a second BIS representing a right audio signal, and the second audio signal included in the second subgroup may include a third Broadcast Isochronous Stream (BIS) representing a left audio signal and a fourth BIS representing a right audio signal.

The control method may further include: providing first sync data corresponding to the first audio signal and second sync data corresponding to the second audio signal; and controlling the communication interface to broadcast the first audio signal, the first sync data, and the second sync data together with the first packet.

The control method may further include: providing guide information if a second user input for a single-audio output that outputs the first audio signal is received while the first packet is broadcast; modifying the second subgroup to include the guide information generated based on the second user input; and broadcasting the first packet modified to include the first subgroup and the modified second subgroup.

The guide information may include information indicating that the single-audio output is performed based on the second user input.

The control method may further include: identifying a first frequency band corresponding to the first audio signal and a second frequency band corresponding to the second audio signal, wherein in the providing of the first packet, the first packet including the first subgroup storing the first frequency band and the second subgroup storing the second frequency band is generated, the first frequency band being different from the second frequency band.

The control method may further include displaying a screen including a list including at least one device available to output the first audio signal, a list including at least one device available to output the second audio signal, and the guide information requesting selection of a device to output the audio signal if the first user input for the multi-audio output is received.

### DESCRIPTION OF DRAWINGS

FIG. 1 is a diagram for describing a system including an electronic device and a plurality of audio devices.

FIG. 2 is a diagram for describing a system including the electronic device, the plurality of audio devices, and a terminal device.

FIG. 3 is a block diagram for describing the electronic device according to various embodiments.

FIG. 4 is a block diagram for describing a specific configuration of the electronic device in FIG. 3.

FIG. 5 is a flowchart for describing an operation of outputting multiple audio signals according to various embodiments.

FIG. 6 is a flowchart for describing an operation of outputting multiple audio signals according to various embodiments.

FIG. 7 is a flowchart for describing an operation of outputting multiple audio signals by using an activated subgroup according to various embodiments.

FIG. 8 is a diagram for describing a packet structure according to various embodiments.

FIG. 9 is a diagram for describing a packet structure according to various embodiments.

FIG. 10 is a diagram for describing a packet structure including two activated subgroups according to various embodiments.

FIG. 11 is a diagram for describing a packet structure including a single activated subgroup according to various embodiments.

FIG. 12 is a flowchart for describing an embodiment of receiving a user command to output a single audio signal while outputting the multiple audio signals according to various embodiments.

FIG. 13 is a flowchart for describing an embodiment of receiving the user command to output the single audio signal while outputting the multiple audio signals according to various embodiments.

FIG. 14 is a flowchart for describing an embodiment of receiving the user command to output the single audio signal while outputting the multiple audio signals according to various embodiments.

FIG. 15 is a flowchart for describing an embodiment of receiving the user command to output the multiple audio signals while outputting the single audio signal according to various embodiments.

FIG. 16 is a diagram for describing various control instructions.

FIG. 17 is a diagram for describing guide audio output in an embodiment that switches from a multi-view function to a single-view function.

FIG. 18 is a flowchart for describing guide audio output in an embodiment that switches from the multi-view function to the single-view function.

FIG. 19 is a diagram for describing guide audio output in an embodiment that switches from the single-view function to the multi-view function.

FIG. 20 is a block diagram for describing the guide audio output in an embodiment that switches from the single-view function to the multi-view function.

FIG. 21 is a diagram for describing an operation of selecting a device to output each of the multiple audio signals in performing the multi-view function.

FIG. 22 is a flowchart for describing a control method for an electronic device according to various embodiments.

### BEST MODE

Hereinafter, the present disclosure is described in detail with reference to the accompanying drawings.

General terms currently widely used are selected as terms used in embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In this specification, an expression “have”, “may have”, “include”, “may include”, or the like indicates the presence of a corresponding feature (for example, a numerical value, a function, an operation, or a component such as a part), and does not exclude the presence of an additional feature.

An expression, “at least one of A or/and B” may indicate either “A or B”, or “both of A and B.”

Expressions “first,” “second,” or the like, used in the present disclosure may indicate various components regardless of the sequence and/or importance of the components. These expressions are used only in order to distinguish one component and another component from each other, and do not limit the corresponding components.

If any component (for example, a first component) is described as being “(operatively or communicatively) coupled with/to or connected to” another component (for example, a second component), it should be understood that any component may be directly coupled to another component or may be coupled to another component through yet another component (for example, a third component).

A term of a singular number may include its plural number unless explicitly indicated otherwise in the context. It should be understood that a term “include” or “formed of” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and be implemented by at least one processor (not shown) except for a “module” or a “˜er/or” that needs to be implemented by a specific hardware.

In this specification, a term “user” may refer to a person using an electronic device or a device using the electronic device (e.g., artificial intelligence electronic device).

Hereinafter, the embodiments of the present disclosure are described in detail with reference to the accompanying drawings.

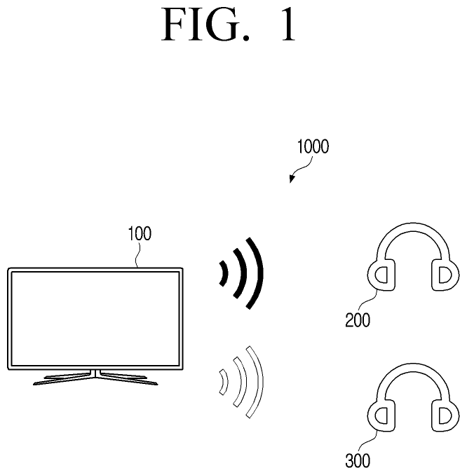

FIG. 1 is a diagram for describing a system 1000 including an electronic device 100 and a plurality of audio devices 200 and 300.

Referring to FIG. 1, the system 1000 may include at least one of the electronic device 100, the first audio device 200, or the second audio device 300.

The electronic device 100 may be a device for transmitting a multiple audio signals. The electronic device 100 may be a device for performing a multi-view function through a display. In addition, the electronic device 100 may be a device for transmitting the multiple audio signals to an external audio device. For example, the electronic device 100 may be a television (TV).

The plurality of audio devices 200 and 300 may be devices for outputting an audio signal based on a communication packet received from the electronic device 100. For example, the plurality of audio devices 200 and 300 may be speakers. Here, the plurality of audio devices 200 and 300 may be devices each including a wireless communication module.

Bluetooth communication may require pairing and connection operations. The pairing operation may include an operation for exchanging address information for mutual communication connection and an operation for registering mutual devices. The pairing operation may include a paging operation for verifying the address information. In addition, the connection operation may indicate an operation for establishing a communication session between devices after performing the pairing operation and an operation for performing 1:1 communication. According to the various embodiments, the pairing operation and the connection operation may be performed as a single operation. The connection operation may include an operation for transmitting information in a state where devices are bonded to each other.

The electronic device 100 may broadcast low energy (LE) audio to at least one audio device present around the electronic device 100. At least one audio device may receive the broadcasted LE Audio. At least one audio device may output the received LE audio.

There may be an embodiment that requires the pairing operation between the electronic device 100 and at least one audio device, and an embodiment that requires no pairing operation.

According to the various embodiments, the electronic device 100 and at least one audio device may be pre-paired to output the broadcasted LE Audio. The electronic device 100 may encrypt the LE Audio. In addition, the electronic device 100 may broadcast the encrypted LE audio. At least one audio device may receive the encrypted LE audio. An encryption key may be required to output the encrypted LE audio. At least one audio device may receive the encryption key from the electronic device 100 through the pairing operation. Therefore, at least one audio device may require the pairing operation to output the encrypted LE audio.

According to the various embodiments, the pairing operation between the electronic device 100 and at least one audio device may not be required to output the broadcasted LE Audio. The electronic device 100 may broadcast unencrypted LE Audio. At least one audio device may receive the unencrypted LE Audio and output the received LE Audio. The LE Audio is unencrypted, and at least one audio device may thus output the LE Audio without the pairing operation.

The connection operation may be required between the electronic device 100 and at least one audio device. At least one audio device that receives the broadcasted LE Audio may not necessarily output the audio signal only after the connection operation. However, at least one connection operation may be required to synchronize the audio signals. Sync data(Synchronization data) may be required to specify an output timing of the LE audio transmitted from the electronic device 100. The electronic device 100 may perform the connection operation and then synchronize its audio signal with that of at least one audio device connected thereto. At least one audio device receiving the LE Audio may receive the sync data from the electronic device 100 after the connection operation. At least one audio device may output the audio signal based on the received sync data. In addition, the electronic device 100 may be disconnected from the electronic device 100. Even if disconnected, at least one audio device may output the synchronized audio signal.

According to the various embodiments, the electronic device 100 may broadcast the audio signal and the sync data. At least one audio device may output the received audio signal based on the sync data.

Therefore, an operation of transmitting the audio signal and the sync data may include an embodiment of transmitting the audio signal and the sync data together, and an embodiment of transmitting the sync data by performing the connection operation after the audio signal is broadcast.

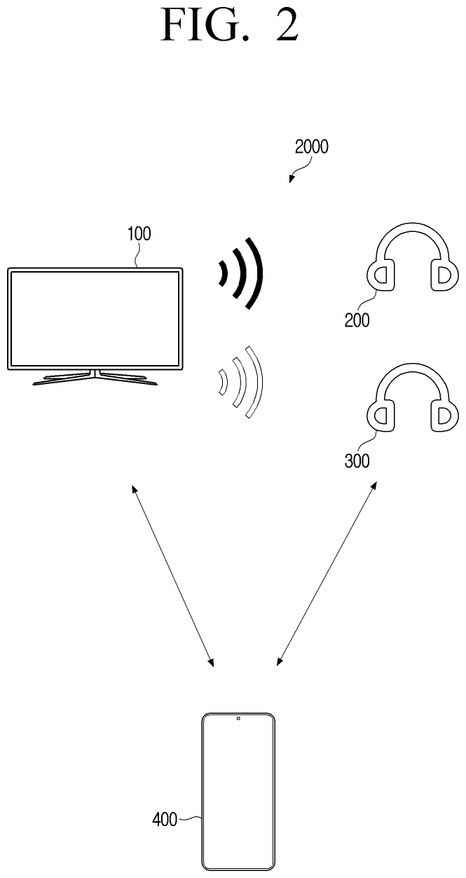

FIG. 2 is a diagram for describing a system 2000 including the electronic device 100, the plurality of audio devices 200 and 300 and a terminal device 400.

Referring to FIG. 2, the system 2000 may include at least one of the electronic device 100, the first audio device 200, the second audio device 300, or the terminal device 400.

The description describes the electronic device 100, the first audio device 200, the second audio device 300, or the like with reference to FIG. 1, and thus omits their redundant descriptions.

The terminal device 400 may be a device that provides a guide user interface (UI) to select one of the multiple audio signals output from the electronic device 100. For example, the terminal device 400 may be a smartphone or a tablet.

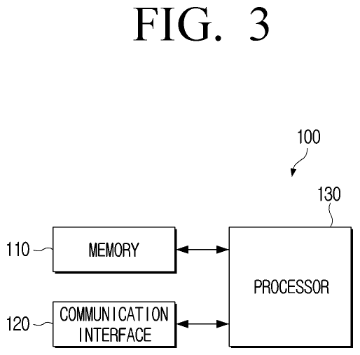

FIG. 3 is a block diagram for describing the electronic device 100 according to various embodiments.

Referring to FIG. 3, the electronic device 100 may include at least one of a memory 110, a communication interface 120, or at least one processor 130.

The memory 110 may store a first audio signal and a second audio signal.

The communication interface 120 may include a Bluetooth low energy (BLE) communication module. The communication interface 120 may be connected to the first audio device and the second audio device via the BLE communication module.

At least one processor 130 may perform overall control operations of the electronic device 100. In detail, at least one processor 130 may perform a function for controlling overall operations of the electronic device 100.

At least one processor 130 may include at least one processor 130 receiving a first user input for a multi-audio output that outputs the first audio signal and the second audio signal simultaneously, activating a first subgroup including the first audio signal and a second subgroup including the second audio signal, generating a first packet including the activated first subgroup and the activated second subgroup, and controlling the communication interface to broadcast the first packet, wherein the first subgroup includes first activation information indicating that the first audio signal is available for output, and the second subgroup includes second activation information indicating that the second audio signal is available for output.

According to the various embodiments, at least one processor 130 may receive a user input for performing a multi-audio output function. The multi-audio output function may be a function for outputting the plurality of audio signals simultaneously.

According to the various embodiments, at least one processor 130 may receive a user input for performing the multi-view function. The multi-view function may be a function for outputting a plurality of contents simultaneously. Here, the plurality of contents may include images and audios, respectively. The audio may be described as the audio signal or audio information.

At least one processor 130 may identify an output target in case of receiving the first user input for performing the multi-audio output function or the multi-view function. The output target may be the first audio signal and the second audio signal. A user may input a control command to the electronic device 100 to output the first audio signal and the second audio signal simultaneously.

The first audio signal and the second audio signal may be output from at least one audio device. At least one processor 130 may exchange information with the first audio device 200 and the second audio device 300 by using Bluetooth low energy (BLE) communication. Here, whether the first audio signal and the second audio signal are output from which audio device may be determined based on the user input (user selection).

It may be assumed that the user selects the first audio signal to be output from the first audio device 200 and the second audio signal to be output from the second audio device 300.

At least one processor 130 may transmit information related to a first subpacket including the first audio signal to the first audio device 200 to enable the first audio signal to be output from the first audio device 200. At least one processor 130 may store identification information of the first audio device 200. In addition, at least one processor 130 may store the identification information of the first audio device 200 in the first subpacket. The first audio device 200 may output the first audio signal included in the first subpacket in case of receiving the identification information of the first audio device 200 included in the first subpacket.

At least one processor 130 may transmit information related to a second subpacket including the second audio signal to the second audio device 300 to enable the second audio signal to output from the second audio device 300. At least one processor 130 may store the identification information of the second audio device 300. In addition, at least one processor 130 may store the identification information of the second audio device 300 in the second subpacket. The second audio device 300 may output the second audio signal included in the second subpacket in case of receiving the identification information of the second audio device 300 included in the second subpacket.

Various methods for broadcasting the communication packet may exist.

According to the various embodiments, at least one processor 130 may include the first audio signal and the second audio signal in a single communication packet (e.g., first packet), and may broadcast the single communication packet.

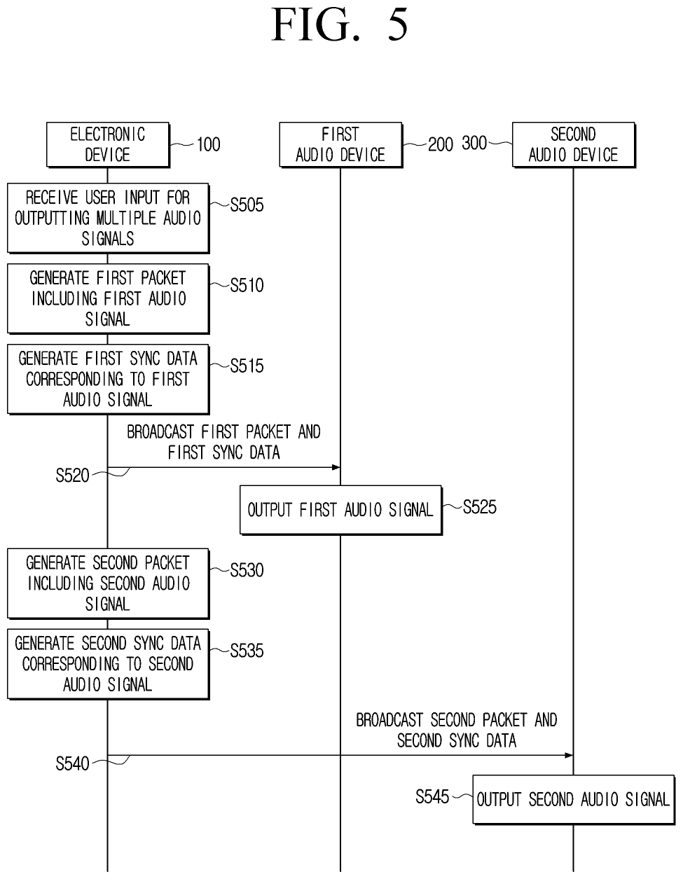

According to the various embodiments, at least one processor 130 may generate and broadcast the packet including the first audio signal and the packet including the second audio signal, respectively. A description of this configuration is described with reference to FIG. 5.

At least one processor 130 may include both the first audio signal and the second audio signal in the first packet. Here, each audio signal may be classified into subgroups. The subgroup may indicate a storage unit for classifying the audio signals corresponding to different contents. The first subgroup may include the first audio signal and information related to the first audio signal, and the second subgroup may include the second audio signal and information related to the second audio signal.

Each subgroup may include activation information. The activation information may be information indicating whether the subgroup is in an activated state or a deactivated state. The activated state may indicate that the audio signal included in a corresponding subgroup is available for output (or available for provision) to the user. The deactivated state may indicate that the audio signal included in the subgroup is not available for output (or not available for provision) to the user. The activation information may be stored in metadata, and the subgroup may include the metadata. The metadata may include various information related to the subgroup.

At least one processor 130 may generate the first activation information indicating that the first audio signal is available for output if the first subgroup is activated.

In addition, at least one processor 130 may generate the second activation information indicating that the second audio signal is available for output if the second subgroup is activated.

In addition, at least one processor 130 may store the first activation information in the first subgroup and the second activation information in the second subgroup.

The first packet may include at least one subgroup. Accordingly, the audio device receiving the first packet may acquire at least one subgroup included in the first packet. In addition, the audio device receiving the first packet may acquire the activation information and the audio signal included in the subgroup. In addition, the audio device may output the audio signal included in the subgroup if data (or value) representing the activated state is identified in the activation information.

At least one processor 130 may generate a control instruction for activating the first subgroup including the first audio signal and for activating the second subgroup including the second audio signal in case of receiving the user input (first user input) for the multi-audio output that outputs the first audio signal and the second audio signal simultaneously.

At least one processor 130 may determine that a state of the first subgroup is the activated state and determine that a state of the second subgroup is the activated state by executing the generated control instruction.

In addition, at least one processor 130 may generate the first packet including the activated first subgroup and the activated second subgroup. The first subgroup and the second subgroup may be stored in the single packet (e.g., first packet).

In addition, at least one processor 130 may broadcast the first packet including the first subgroup and the second subgroup via the communication interface 120.

Meanwhile, at least one processor 130 may deactivate the second subgroup in case of receiving a second user input for a single-audio output that outputs the first audio signal while broadcasting the first packet, modify the first packet to include only the activated first subgroup, and control the communication interface 120 to broadcast the modified first packet.

At least one processor 130 may receive the second user input for the single-audio output while broadcasting the first packet including the first audio signal and the second audio signal based on the first user input for the multi-audio output. The second user input may be a command to output only the first audio signal.

At least one processor 130 may receive the second user input for the single-audio output while outputting the first audio signal and the second audio signal simultaneously through at least one audio device.

At least one processor 130 may maintain the first subgroup and deactivate the second subgroup in case of receiving the second user input for the single-audio output that outputs the first audio signal while performing the multi-audio output function. At least one processor 130 may switch the second subgroup from the activated state to the deactivated state to enable the first packet to be broadcast without interruption.

According to the various embodiments, at least one processor 130 may broadcast the first packet including only the activated first subgroup without including the deactivated second subgroup.

According to the various embodiments, at least one processor 130 may remove the second audio signal included in the deactivated second subgroup and include null data. In addition, at least one processor 130 may broadcast the first packet including the first subgroup and the second subgroup.

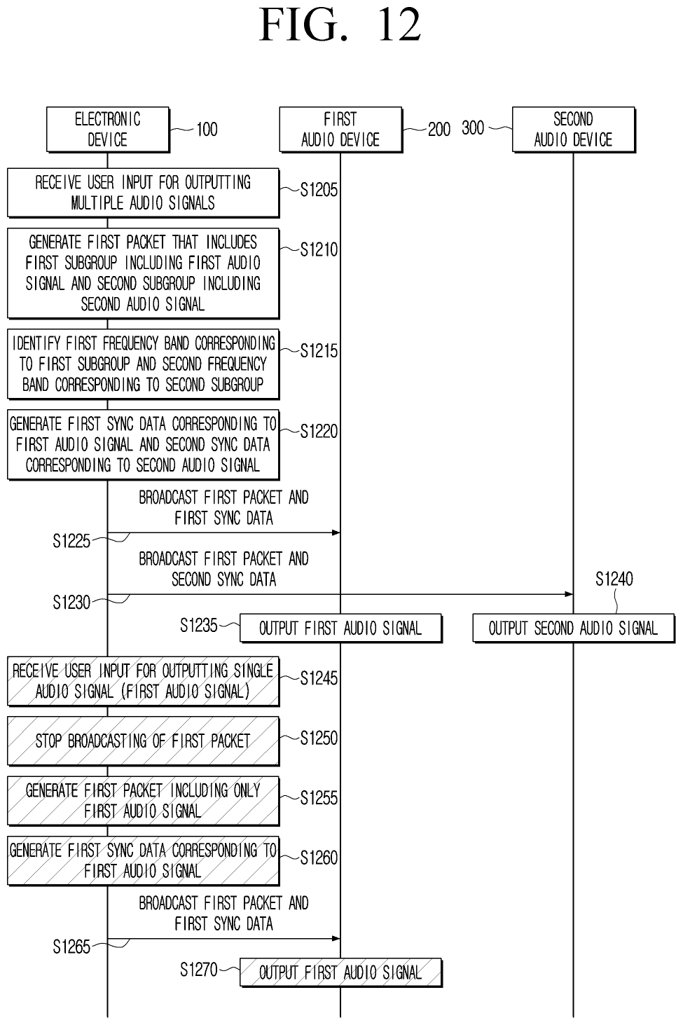

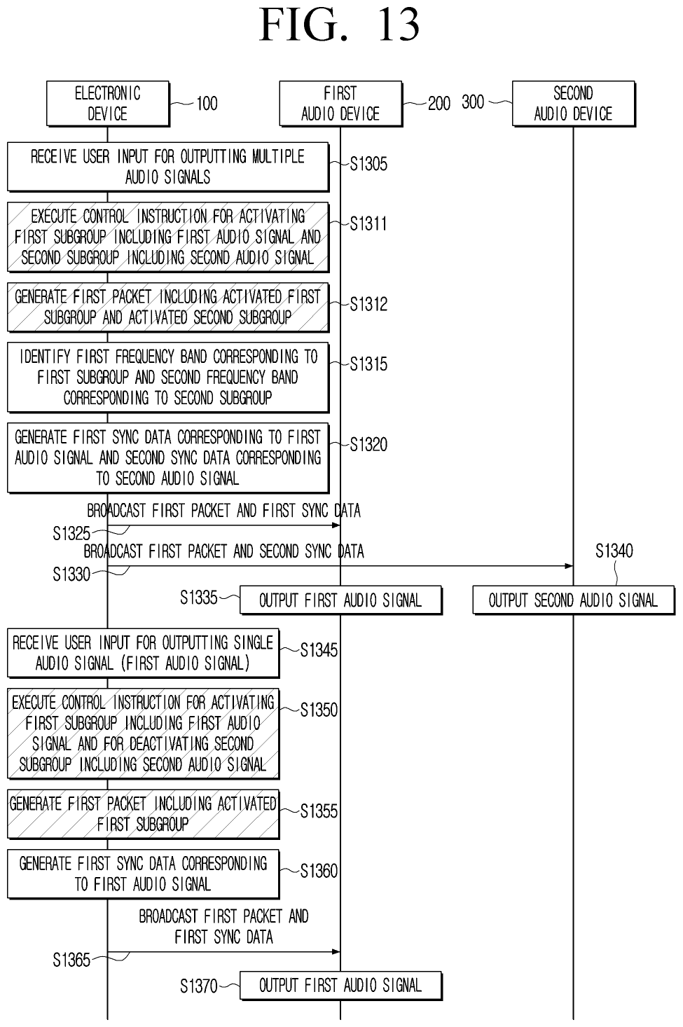

A specific embodiment of switching from the multi-audio output function to the single-audio output function is described with reference to FIGS. 12 and 13.

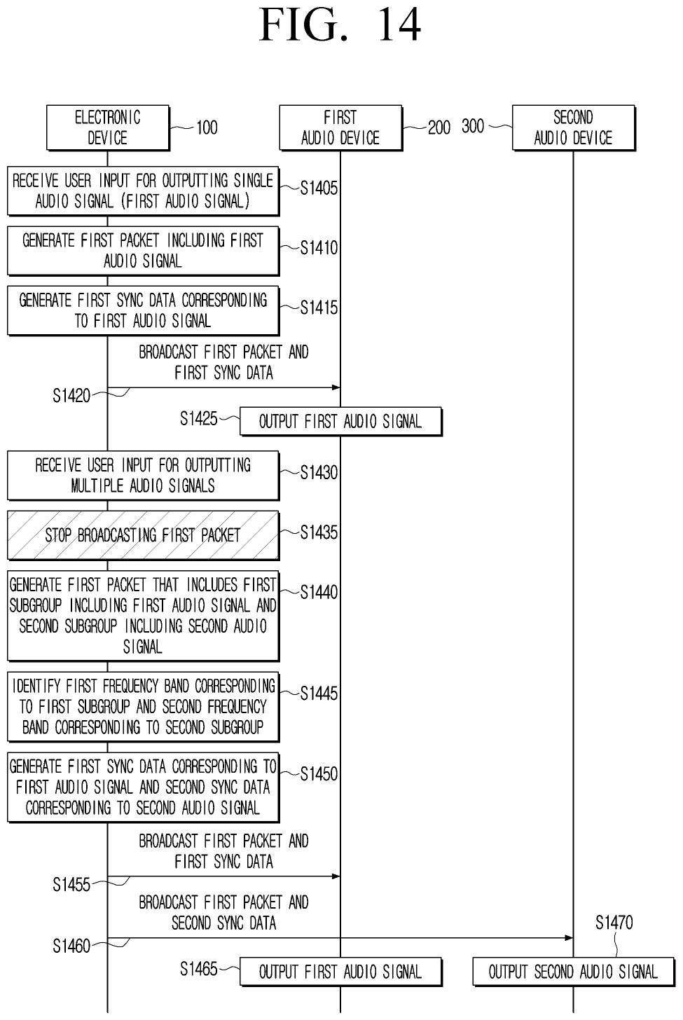

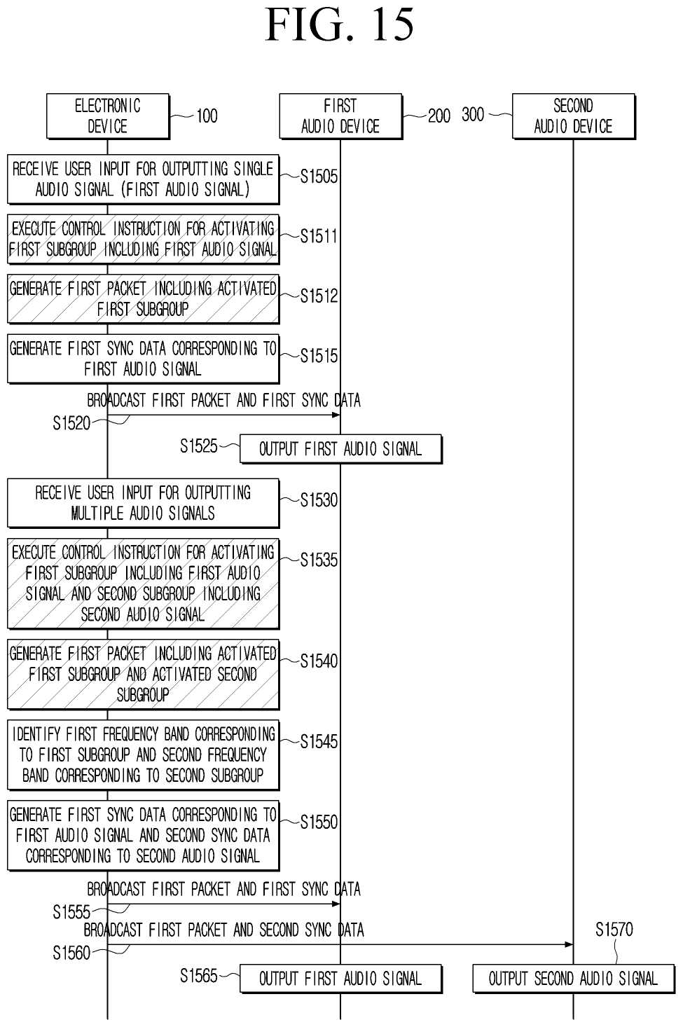

A specific embodiment of switching from a single-audio output function to the multi-audio output function is described with reference to FIGS. 14 and 15.

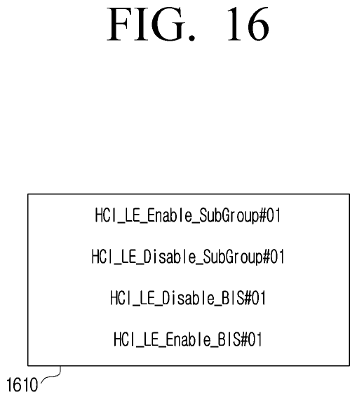

Meanwhile, at least one processor 130 may identify an instruction for deactivating the second subgroup among a plurality of host controller interface (HCI) instructions stored in the memory 110, and deactivate the second subgroup by executing the identified instruction. A description of the HCI instruction is described with reference to FIG. 16.

Meanwhile, the first packet may include advertising data, the advertising data may include information on the number of subgroups, the first subgroup, and the second subgroup, each of the first subgroup and the second subgroup may include at least one of a codec identifier (ID), codec configuration information, the metadata, or the audio signal, and the metadata may include the activation information indicating that the audio signal is available for output.

Meanwhile, the first audio signal included in the first subgroup may include a first Broadcast Isochronous Stream (BIS) representing a left audio signal and a second BIS representing a right audio signal, and the second audio signal included in the second subgroup may include a third Broadcast Isochronous Stream (BIS) representing a left audio signal and a fourth BIS representing a right audio signal.

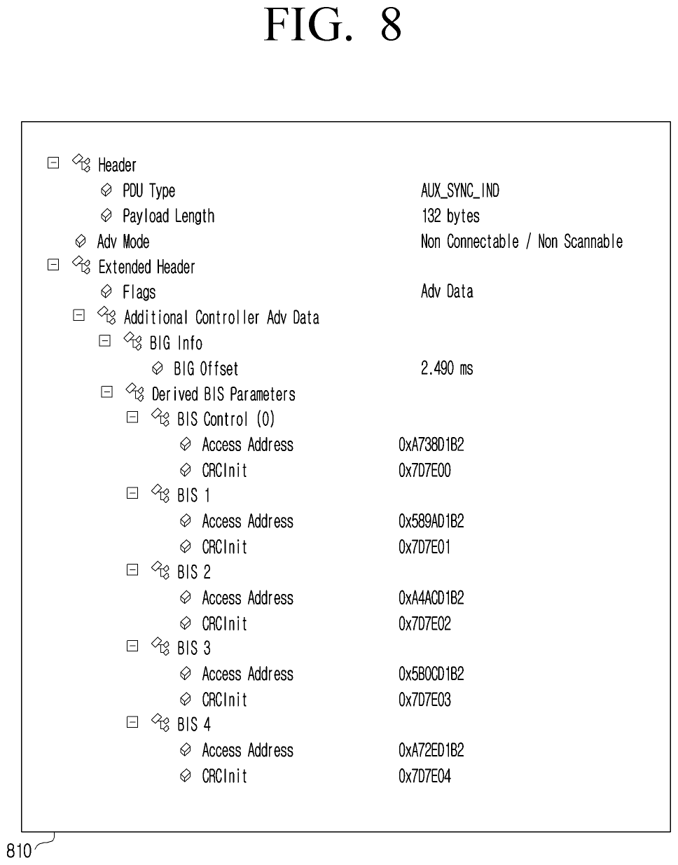

A specific description of a packet structure is described with reference to FIGS. 8 to 11.

Meanwhile, at least one processor 130 may generate first sync data corresponding to the first audio signal and second sync data corresponding to the second audio signal, and control the communication interface 120 to broadcast the first audio signal, the first sync data, and the second sync data together with the first packet.

The sync data may be data used to synchronize an intended output timing of the electronic device 100 with an output timing at which the packet is received and the audio signal is output. At least one processor 130 may generate the first sync data to control the output timing of the first audio signal and generate the second sync data to control the output timing of the second audio signal. The output timing may be determined based on the first sync data if the first audio device 200 outputs the first audio signal. The output timing may be determined based on the second sync data if the second audio device 300 outputs the second audio signal.

An additional operation related to the sync data is described with reference to FIGS. 5 to 7.

Meanwhile, at least one processor 130 may generate guide information in case of receiving the second user input for the single-audio output that outputs the first audio signal while broadcasting the first packet, modify the second subgroup to include the guide information, modify the first packet to include the first subgroup and the modified second subgroup, and control the communication interface 120 to broadcast the modified first packet.

Meanwhile, the guide information may include information indicating that the single-audio output is performed based on the second user input.

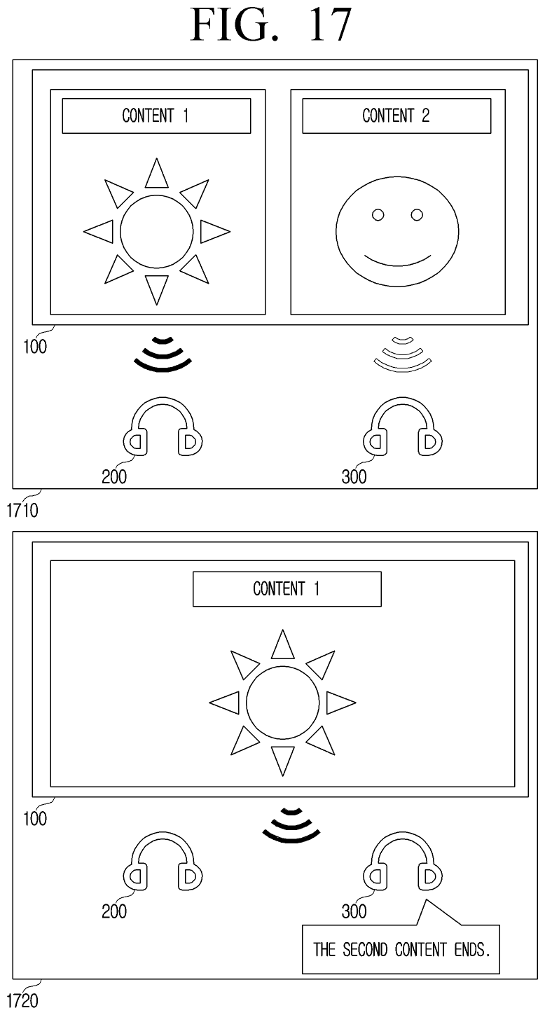

An operation of outputting the guide information is described with reference to FIGS. 17 to 20.

Meanwhile, at least one processor 130 may identify a first frequency band corresponding to the first audio signal and a second frequency band corresponding to the second audio signal, and generate the first packet including the first subgroup storing the first frequency band and the second subgroup storing the second frequency band, the first frequency band being different from the second frequency band.

At least one processor 130 may use different frequency bands to classify different audio signals simultaneously. At least one processor 130 may allocate the first frequency band to the first audio signal and the second frequency band to the second audio signal. The first audio device 200 may output only the first audio signal transmitted in the first frequency band. The second audio device 300 may output only the second audio signal transmitted in the second frequency band.

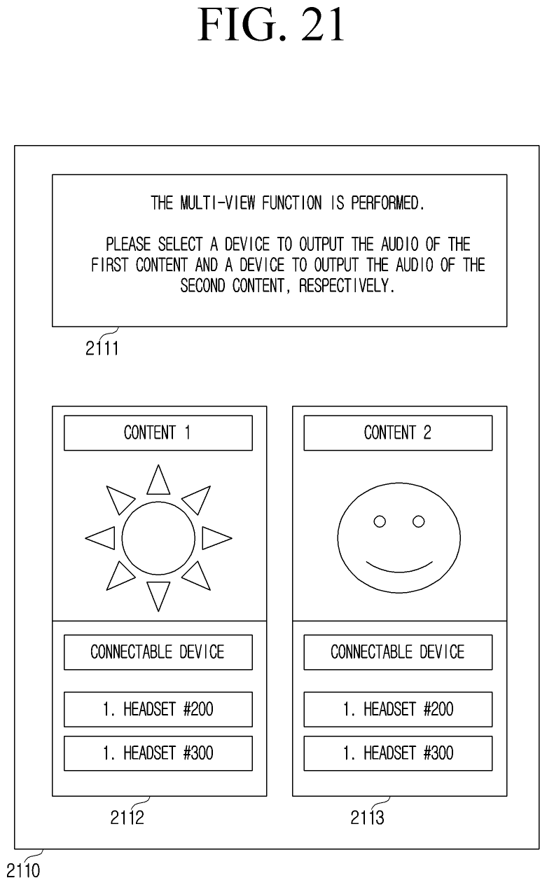

Meanwhile, the electronic device 100 may further include a display 140, and at least one processor 130 may control the display 140 to display a screen including a list including at least one device capable of outputting the first audio signal, a list including at least one device capable of outputting the second audio signal, and the guide information requesting selection of a device to output the audio signal in case of receiving the first user input for the multi-audio output. An embodiment of this configuration is described with reference to FIG. 21.

According to the various embodiments, the electronic device 100 may perform a function for receiving the user input and a function for broadcasting the communication packet, and an external server may generate the communication packet. In detail, the electronic device 100 may transmit the user input to the external server in case of receiving the user input. The external server may activate the first subgroup including the first audio signal and the second subgroup including the second audio signal based on the user input in case of receiving the user input. In addition, the external server may generate the first packet including the activated first subgroup and the activated second subgroup. In addition, the external server may transmit the generated first packet to the electronic device 100. The electronic device 100 may receive the first packet from the external server and broadcast the received first packet. The broadcasted first packet may be received by at least one of the first audio device 200 or the second audio device 300.

The electronic device 100 according to the various embodiments may determine the provision of the multiple audio signals (audio stream) through the single packet, thereby reducing the interruption compared to a method for providing the multiple audio signals through separate packets. In addition, a method for including only the activated subgroup may be more efficient in terms of space utilization than a method for applying the null data to an unused packet region.

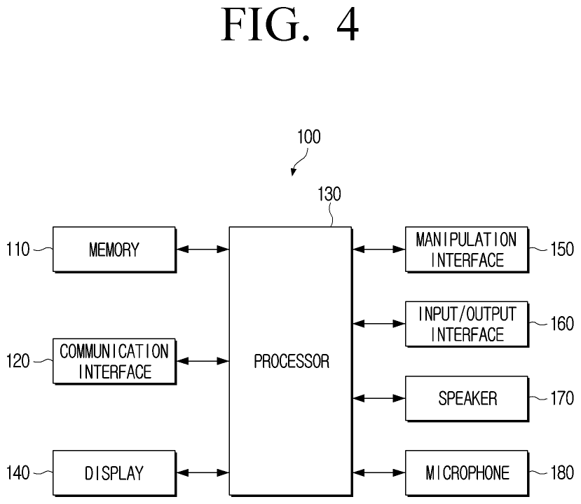

Meanwhile, only the brief components included in the electronic device 100 are shown and described hereinabove. However, in implementation, the electronic device 100 may include various additional components. A description of these components is provided below with reference to FIG. 4.

FIG. 4 is a block diagram for describing a specific configuration of the electronic device 100 in FIG. 3.

Referring to FIG. 4, the electronic device 100 may include at least one of the memory 110, the communication interface 120, at least one processor 130, the display 140, a manipulation interface 150, an input/output interface 160, a speaker 170, or a microphone 180. The description omits a redundant description of the same operation as described above.

The electronic device 100 according to the various embodiments of this specification may include, for example, at least one of a smartphone, a tablet personal computer (PC), a mobile phone, a desktop PC, a laptop PC, a personal digital assistant (PDA), or a portable multimedia player (PMP). In some embodiments, for example, the electronic device 100 may include at least one of a television, a digital video disk (DVD) player, or a media box (e.g., Samsung HomeSync™, Apple TV™, or Google TV™).

The memory 110 may be implemented as an internal memory included in the processor 130, such as a read-only memory (ROM, e.g., electrically erasable programmable read-only memory (EEPROM)) or a random access memory (RAM), or as a memory separate from the processor 130. In this case, the memory 110 may be implemented in the form of a memory embedded in the electronic device 100 or in the form of a memory detachable from the electronic device 100, based on a data storage purpose. For example, data for driving the electronic device 100 may be stored in the memory embedded in the electronic device 100, and data for an extension function of the electronic device 100 may be stored in the memory detachable from the electronic device 100.

Meanwhile, the memory embedded in the electronic device 100 may be implemented as at least one of a volatile memory (e.g., dynamic RAM (DRAM), static RAM (SRAM), or synchronous dynamic RAM (SDRAM)) or a non-volatile memory (e.g., one time programmable ROM (OTPROM), programmable ROM (PROM), erasable and programmable ROM (EPROM), electrically erasable and programmable ROM (EEPROM), a mask ROM, a flash ROM, a flash memory (e.g., NAND flash or NOR flash), a hard drive, or a solid state drive (SSD)); and the memory detachable from the electronic device 100 may be implemented as a memory card (e.g., compact flash (CF), secure digital (SD), micro secure digital (Micro-SD), mini secure digital (mini-SD), extreme digital (xD), or multi-media card (MMC)) or as an external memory capable of being connected to a universal serial bus (USB) port (e.g., USB memory), or the like.

The communication interface 120 is a component for performing communication with various types of external devices by using various types of communication methods. The communication interface 120 may include the wireless communication module or a wired communication module. Here, each communication module may be implemented in the form of at least one hardware chip.

The wireless communication module may be a module that communicates with the external device in a wireless manner. For example, the wireless communication module may include at least one of a wireless fidelity (Wi-Fi) module, a Bluetooth module, an infrared communication module, or another communication module.

The Wi-Fi module and the Bluetooth module may respectively perform the communication in a Wi-Fi manner and a Bluetooth manner. In case of using the Wi-Fi module or the Bluetooth module, the communication interface 120 may first transmit and receive various connection information such as a service set identifier (SSID) or a session key, establish the communication by using this connection information, and then transmit and receive various information.

The infrared communication module may perform the communication based on infrared data association (IrDA) technology to transmit data in a short distance in the wireless manner by using an infrared ray between visible light and millimeter waves.

In addition to the above-described communication manners, another communication module may include at least one communication chip for performing the communication according to various wireless communication standards such as Zigbee, third generation (3G), third generation partnership project (3GPP), long term evolution (LTE), LTE advanced (LTE-A), fourth generation (4G), and fifth generation (5G).

The wired communication module may be a module for performing the communication with the external device in a wired manner. For example, the wired communication module may include at least one of a local area network (LAN) module, an Ethernet module, a pair cable, a coaxial cable, an optical fiber cable, or an ultra wide-band (UWB) module.

The processor 130 may be implemented as a digital signal processor (DSP), a microprocessor, or a time controller (TCON), processing a digital signal. However, the processor 130 is not limited thereto, may include at least one of a central processing unit (CPU), a micro controller unit (MCU), a micro processing unit (MPU), a controller, an application processor (AP), a graphics-processing unit (GPU), a communication processor (CP) or an advanced reduced instruction set computer (RISC) machine (ARM) processor, or may be defined by these terms. In addition, the processor 130 may be implemented in a system-on-chip (SoC) or a large-scale integration (LSI), in which a processing algorithm is embedded, or may be implemented in the form of a field-programmable gate array (FPGA). In addition, the processor 130 may perform various functions by executing computer executable instructions stored in the memory. The display 140 may be implemented as any of various types of displays such as a liquid crystal display (LCD), an organic light emitting diode (OLED) display, or a plasma display panel (PDP). The display 140 may also include a driving circuit, a backlight unit, and the like, which may be implemented in a form such as an amorphous silicon thin-film transistor (a-si TFT), a low-temperature polycrystalline silicon (LTPS) TFT, or an organic TFT (OTFT). Meanwhile, the display 140 may be implemented as a touchscreen coupled with a touch sensor, a flexible display, a three-dimensional (3D) display, or the like. In addition, the display 140 according to an embodiment of the present disclosure may include not only a display panel that outputs an image, but also a bezel that houses the display panel. In particular, the bezel may include the touch sensor (not shown) for detecting user interaction according to an embodiment of the present disclosure.

According to the various embodiments, the electronic device 100 may include the display 140. In detail, the electronic device 100 may directly display the acquired image or content on the display 140.

According to the various embodiments, the electronic device 100 may not include the display 140. The electronic device 100 may be connected to an external display device, and may transmit the image or the content stored in the electronic device 100 to the external display device. In detail, the electronic device 100 may transmit the image or the content to the external display device along with a control signal for controlling the image or the content to be displayed on the external display device. Here, the external display device may be connected to the electronic device 100 via the communication interface 120 or the input/output interface 160. For example, the electronic device 100 may include no display like a set top box (STB). In addition, the electronic device 100 may include only a small display capable of displaying only simple information such as text information. Here, the electronic device 100 may transmit the image or the content to the external display device in the wired or wireless manner via the communication interface 120, and transmit the image or the content to the external display device via the input/output interface 160.

The manipulation interface 150 may be implemented as a device such as a button, a touch pad, a mouse or a keyboard, or may also be implemented as a touchscreen capable of also performing a manipulation input function in addition to the above-described display function. Here, the button may be any of various types of buttons such as a mechanical button, a touchpad, a wheel, or the like, which is disposed in any region, such as the front surface portion, side surface portion, or rear surface portion of a body appearance of the electronic device 100.

The input/output interface 160 may be any of a high definition multimedia interface (HDMI), a mobile high-definition link (MHL), a universal serial bus (USB), a display port (DP), a Thunderbolt port, a video graphics array (VGA) port, a red-green-blue (RGB) port, a D-subminiature (D-SUB) port, or a digital visual interface (DVI) port. The input/output interface 160 may input/output at least one of the audio signal or a video signal. According to an implementation example, the input/output interface 160 may include a port for inputting and outputting only the audio signal and a port for inputting and outputting only the video signal as separate ports, or may be implemented as a single port for inputting and outputting both the audio signal and the video signal. Meanwhile, the electronic device 100 may transmit at least one of the audio signal or the video signal to the external device (e.g., external display device or external speaker) through the input/output interface 160. In detail, the output port included in the input/output interface 160 may be connected to the external device, and the electronic device 100 may transmit at least one of the audio signal or the video signal to the external device through the output port.

Here, the input/output interface 160 may be connected with the communication interface. The input/output interface 160 may transmit information received from the external device to the communication interface, or transmit information received via the communication interface to the external device.

The speaker 170 is a component for outputting not only various audio data but also various notification sounds, voice messages, or the like.

The microphone 180 is a component for receiving a user voice or other sounds to convert the same into the audio data. The microphone 180 may receive the user voice while activated. For example, the microphone 180 may be integrally formed in the upper, front, or side direction of the electronic device 100. The microphone 180 may include various components such as a microphone that collects the user voice in an analog form, an amplifier circuit that amplifies the collected user voice, an analog to digital (A/D) conversion circuit that samples the amplified user voice and converts the same into the digital signal, a filter circuit that removes a noise component from the converted digital signal, and the like.

FIG. 5 is a flowchart for describing an operation of outputting the multiple audio signals according to various embodiments.

Referring to FIG. 5, the electronic device 100 may receive the user input for outputting the multiple audio signals (S505). The user input may include a command to transmit the first audio signal to the first audio device 200 and the second audio signal to the second audio device 300. The electronic device 100 may receive the user input from the terminal device 400.

The electronic device 100 may generate the first packet including the first audio signal (S510). The electronic device 100 may generate the first sync data corresponding to the first audio signal (S515). The electronic device 100 may broadcast the first packet and the first sync data (S520).

The first packet and the first sync data are described as being broadcast separately in operation S520. However, according to the various embodiments, the sync data may be broadcast in a form in which the sync data is included in the packet. An embodiment in which the sync data is included in the packet may be applied to all descriptions provided below.

The first audio device 200 may receive the first packet and the first sync data from the electronic device 100. The first audio device 200 may output the first audio signal included in the received first packet (S525). The first audio device 200 may output the first audio signal based on the received first sync data. The electronic device 100 may output a first image signal based on the first sync data. The first audio device 200 may synchronize the first image signal with the first audio signal based on the first sync data if the electronic device 100 outputs the first image signal.

The electronic device 100 may generate a second packet including the second audio signal (S530). The electronic device 100 may generate the second sync data corresponding to the second audio signal (S535). The electronic device 100 may broadcast the second packet and the second sync data (S540).

The second audio device 200 may receive the second packet and the second sync data from the electronic device 100. The second audio device 200 may output the second audio signal included in the received second packet (S545). The second audio device 200 may output the second audio signal based on the received second sync data. The electronic device 100 may output a second image signal based on the second sync data. The second audio device 200 may synchronize the second image signal with the second audio signal based on the second sync data if the electronic device 100 outputs the second image signal.

The first packet and the second packet may be the communication packets. In detail, the first packet and the second packet may be packets used in the Bluetooth communication. In particular, the Bluetooth communication may be implemented as the Bluetooth low energy (BLE) communication.

Meanwhile, with reference to FIG. 5, the description describes that the packet and the sync data are transmitted together to the audio device. According to the various embodiments, the packet may be broadcast, the connection operation may then be performed separately between the electronic device 100 and the audio device, and the sync data may then be transmitted from the electronic device 100 to the audio device. An embodiment in which the connection operation is performed separately between the electronic device 100 and the audio device and the sync data is then transmitted from the electronic device 100 to the audio device may also be equally applied to the descriptions provided below with reference to the drawings.

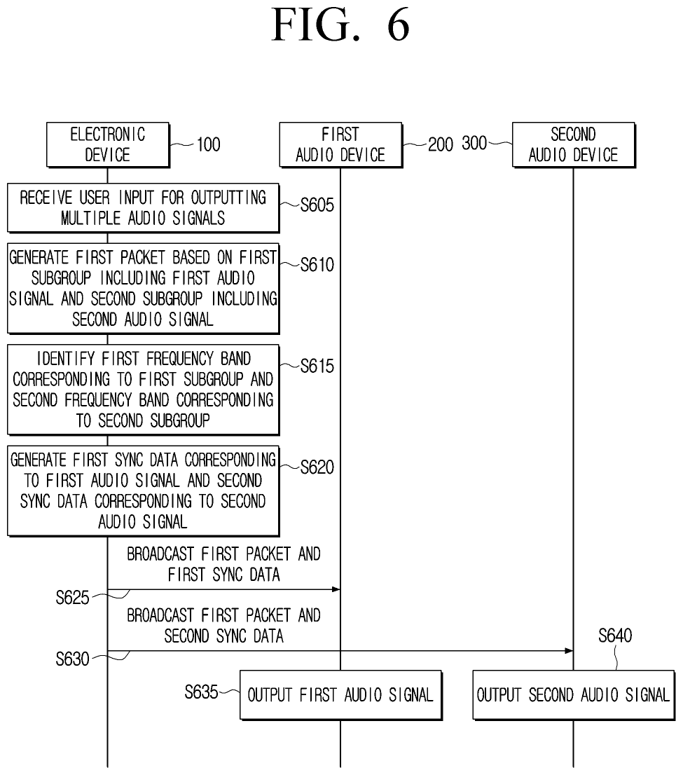

FIG. 6 is a flowchart for describing an operation of outputting the multiple audio signals according to various embodiments.

Referring to FIG. 6, the electronic device 100 may receive the user input for outputting the multiple audio signals (S605). The user input may include a command to transmit the first audio signal to the first audio device 200 and the second audio signal to the second audio device 300. The electronic device 100 may receive the user input from the terminal device 400.

The electronic device 100 may generate the first packet based on the first subgroup including the first audio signal and the second subgroup including the second audio signal (S610). The first packet may include the first audio signal and the second audio signal as separate subgroups, respectively.

The electronic device 100 may identify the first frequency band corresponding to the first subgroup and the second frequency band corresponding to the second subgroup (S615). The first frequency band and the second frequency band may be different from each other.

The electronic device 100 may generate the first sync data corresponding to the first audio signal and the second sync data corresponding to the second audio signal (S620).

The electronic device 100 may broadcast the first packet and the first sync data (S625). The electronic device 100 may broadcast the second packet and the second sync data (S630).

The first audio device 200 may receive the first packet and the first sync data transmitted from the electronic device 100. In addition, the first audio device 200 may output the first audio signal included in the first packet based on the first sync data (S635). The first audio device 200 may output the first audio signal based on the first sync data while the electronic device 100 outputs the first image signal based on the first sync data. Therefore, the first image signal and the first audio signal may be synchronized with each other.

The second audio device 200 may receive the second packet and the second sync data transmitted from the electronic device 100. In addition, the second audio device 200 may output the second audio signal included in the second packet based on the second sync data (S640). The second audio device 200 may output the second audio signal based on the second sync data while the electronic device 100 outputs the second image signal based on the second sync data. Therefore, the second image signal and the second audio signal may be synchronized with each other.

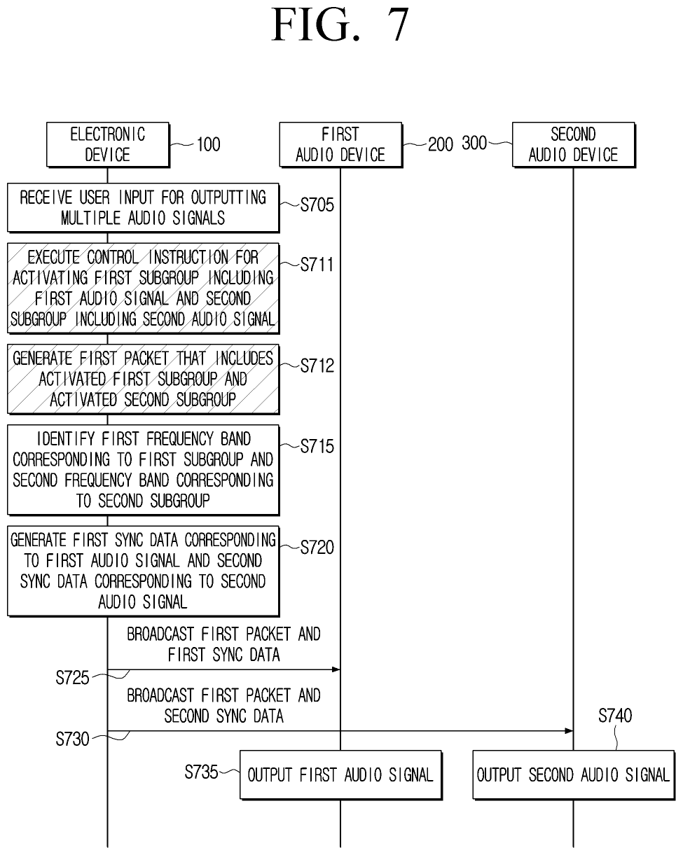

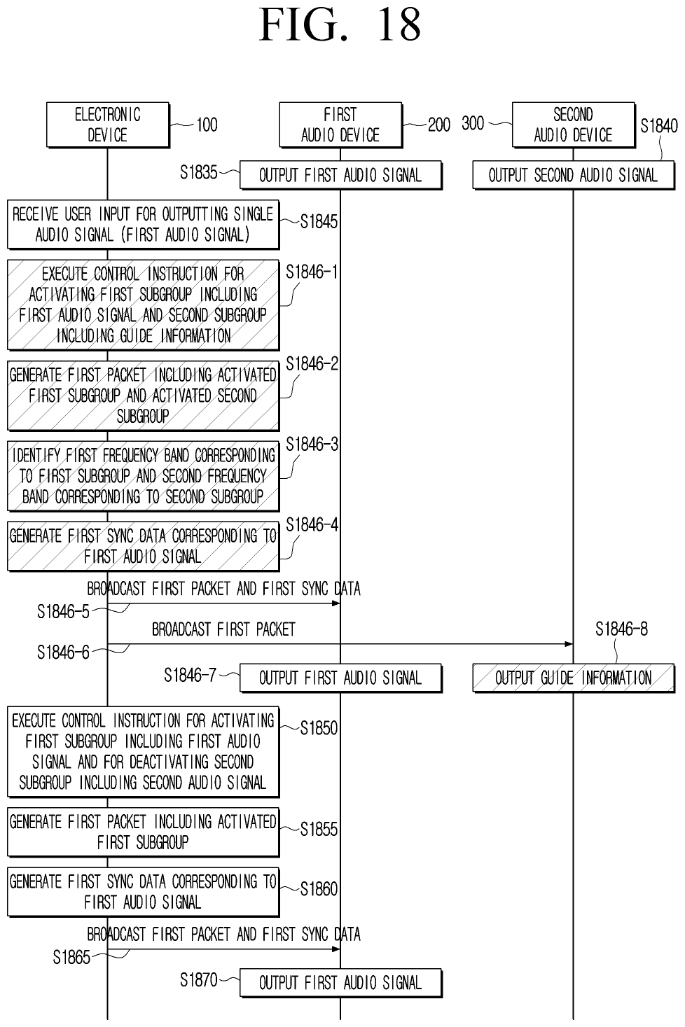

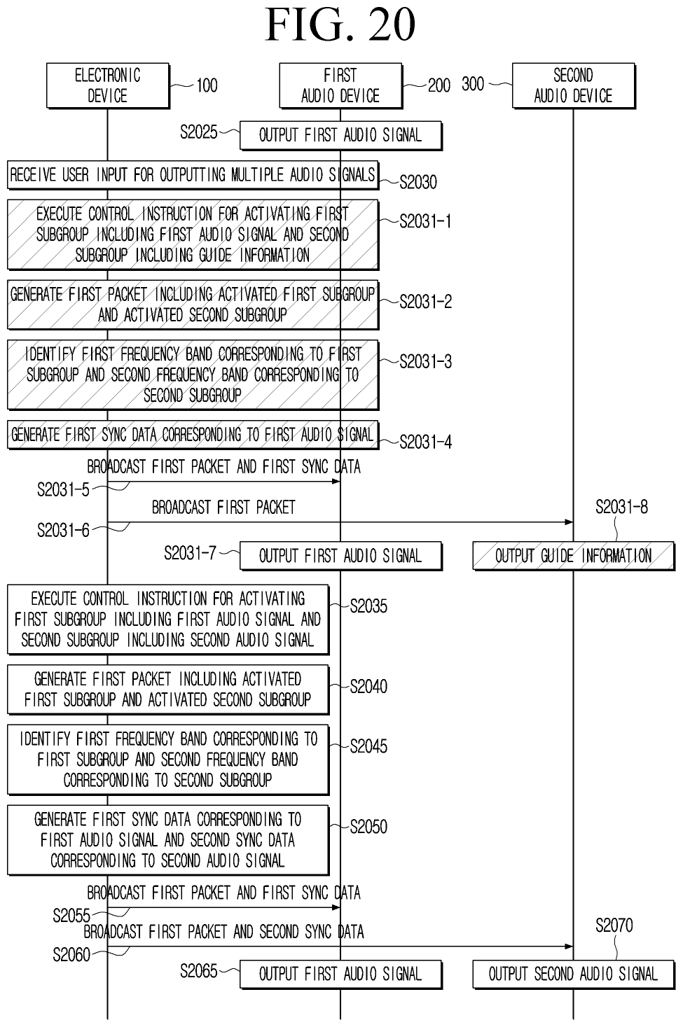

Meanwhile, referring to FIG. 6, the operation of outputting the first audio signal (S635) is described as being performed after the operation of broadcasting the first packet and the second sync data (S630). According to the various embodiments, the operation of outputting the first audio signal (S635) may be performed before the operation of broadcasting the first packet and the second sync data (S630). The description of a temporal relationship between these operations may also be equally applied to the following: operation S735 in FIG. 7, operation S1235 in FIG. 12, operation S1335 in FIG. 13, operation S1465 in FIG. 14, the operation S1565 in FIG. 15, operation S1846-7 in FIG. 18, and operations S2031-7 and S2065 in FIG. 20.

FIG. 7 is a flowchart for describing an operation of outputting the multiple audio signals by using the activated subgroup according to various embodiments.

Operations S705, S715, S720, S725, S730, S735, and S740 in FIG. 7 may correspond to operations S605, S615, S620, S625, S630, S635, and S640 in FIG. 6. Their redundant descriptions are thus omitted.

The electronic device 100 may execute the control instruction for activating the first subgroup including the first audio signal and the second subgroup including the second audio signal after receiving the user input for outputting the multiple audio signals (S711). The subgroup may include attribute information related to whether the subgroup is activated. The attribute information may be described as the activation information.

The activation information may indicate whether to output the audio signal included in the subgroup. The electronic device 100 may generate the first packet that includes the activated subgroup if the activation information includes a first value for activating the subgroup. The electronic device 100 may generate the first packet that does not include the deactivated subgroup if the activation information includes a second value for deactivating the subgroup. As a result, the first packet may include only the activated subgroup.

According to the various embodiments, the deactivated subgroup may include the null data instead of the audio signal. For example, the electronic device 100 may generate the first packet that includes the null data in the deactivated subgroup if the activation information includes the second value for deactivating the subgroup.

The electronic device 100 may generate the first packet that includes the activated first subgroup and the activated second subgroup if the control instruction for activating both the first subgroup and the second subgroup is executed (S712).

The electronic device 100 may then perform operations S715 to S740.

FIG. 8 is a diagram for describing the packet structure according to various embodiments.

Referring to FIG. 8, Embodiment 810 may represent a header region of the packet. The header region may include a default region (Header) and an additional region (Extended Header).

The default region may include at least one of a protocol data unit (PDU) type or a payload length.

The additional region may include at least one of information related to a Broadcast Isochronous Group (BIG) or a Broadcast Isochronous Stream (BIS) parameter. The BIS parameter may include at least one of an address value or a Cyclic Redundancy Check (CRC) initial value.

In Embodiment 810, four BIS may be provided. Two BIS may be included in one audio signal. The reason is that a single audio signal may include the left audio signal and the right audio signal.

The first audio signal may include two BIS BIS 1 and BIS 2. BIS 1 may be a left audio signal of the first audio signal, and BIS 2 may be a right audio signal of the first audio signal. In addition, the second audio signal may include two BIS BIS 3 and BIS 4. BIS 3 may be a left audio signal of the second audio signal, and BIS 4 may be a right audio signal of the second audio signal.

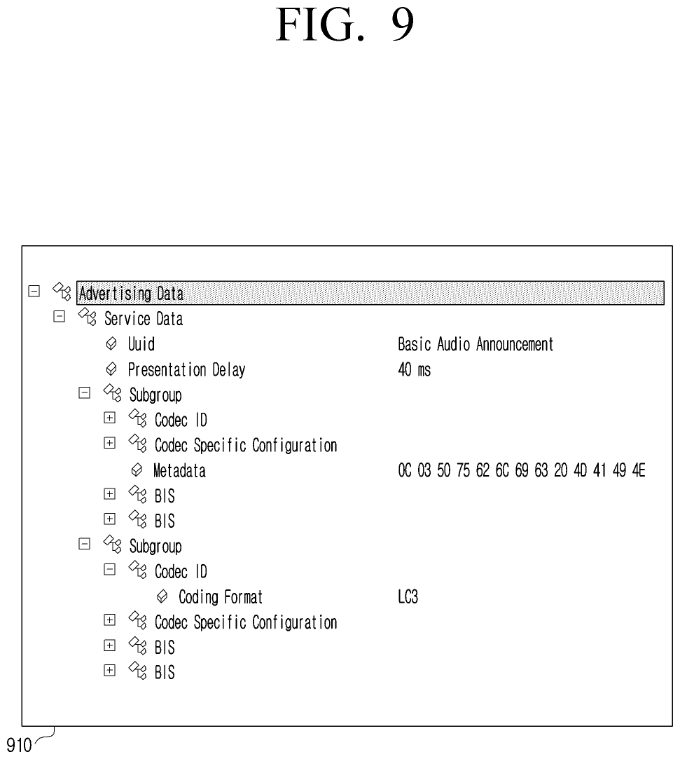

FIG. 9 is a diagram for describing a packet structure according to various embodiments.

Referring to FIG. 9, Embodiment 910 shows a structure of the advertising data. The advertising data may include at least one of service data or the subgroup. According to the various embodiments, the plurality of subgroups may be provided.

The service data may include at least one of a universally unique identifier (UUID) or delay time information.

The subgroup may include at least one of the codec ID, the codec configuration information, the metadata, or the BIS. According to the various embodiments, the plurality of BIS may be provided. The metadata may include information related to the audio signal.

In addition, the metadata may include the activation information. The metadata may include information on whether the audio signal currently included in the subgroup is activated. The audio device for receiving the advertising data may acquire the activation information from the metadata. In addition, the audio device may determine whether to output the audio signal based on the activation information. The audio device may output the audio signal included in the subgroup if the subgroup is identified as activated based on the activation information.

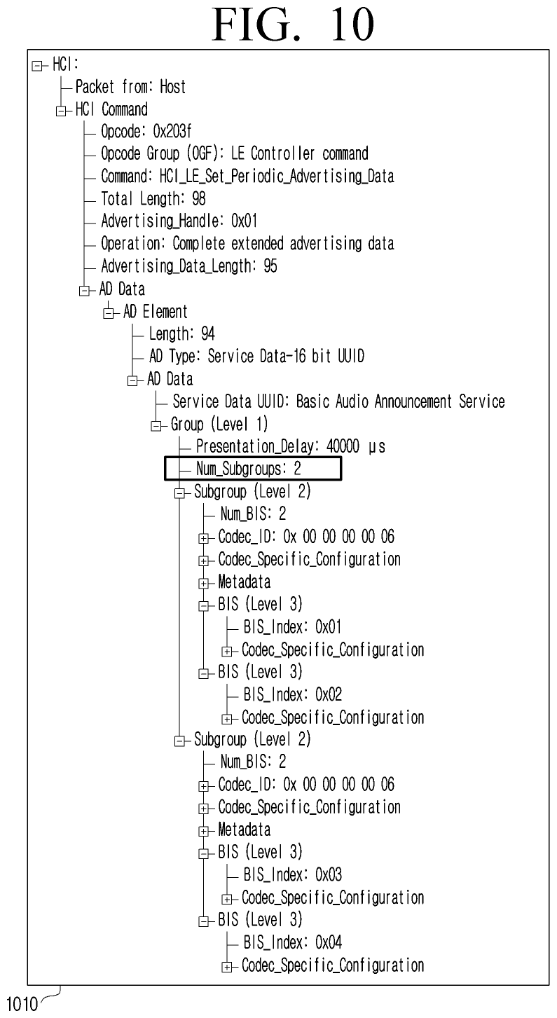

FIG. 10 is a diagram for describing a packet structure including two activated subgroups according to various embodiments.

Referring to FIG. 10, Embodiment 1010 shows a host controller interface (HCI) structure. The HCI may include at least one of information related to an opcode, instruction information, or the advertising data.

The advertising data may include at least one of length information, the universally unique identifier (UUID), or group information

The group information may include delay information, the information on the number of subgroups, or the subgroup. According to the various embodiments, the plurality of subgroups may be provided. Each subgroup may include at least one of information on the number of BIS, the codec ID, the codec configuration information, the metadata, or the BIS. BIS may include BIS identification information BIS_index or the audio signal.

For example, it may be assumed that two audio signals are output as a single packet. The number of subgroups may be two. In addition, the subgroup may be classified into the first subgroup and the second subgroup. The number of BIS in the first subgroup may be two, and the number of BIS in the second subgroup may be two.

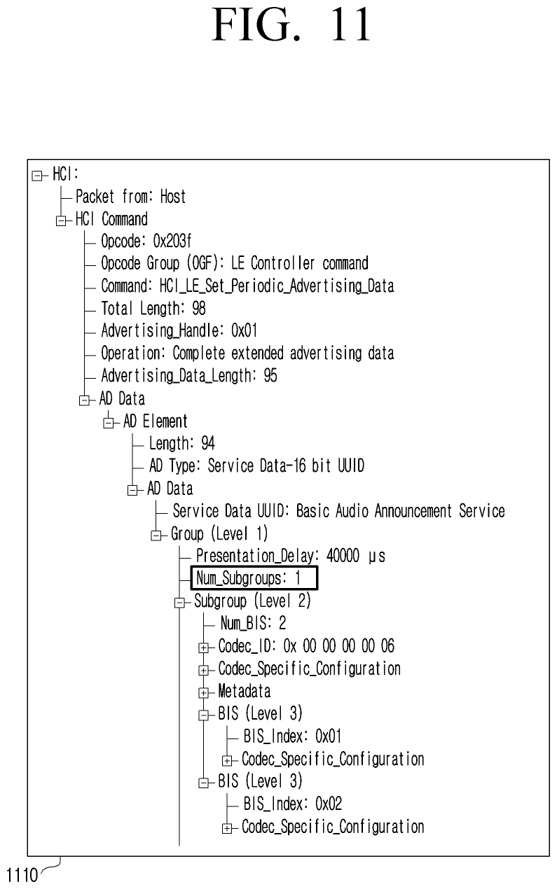

FIG. 11 is a diagram for describing a packet structure including a single activated subgroup according to various embodiments.

Referring to FIG. 11, Embodiment 1110 shows the advertising data including a single subgroup. With reference to FIG. 10, the description describes the advertising data including two subgroups. A redundant description thereof is thus omitted. The number of subgroups in the advertising data of Embodiment 1110 may be one.

FIG. 12 is a flowchart for describing an embodiment of receiving a user command to output a single audio signal while outputting the multiple audio signals according to various embodiments.

Operations S1205, S1210, S1215, S1220, S1225, S1230, S1235, S1240 in FIG. 12 may correspond to operations S605, S610, S615, S620, S625, S630, S635, and S640. Their redundant descriptions are thus omitted.

Based on the user input for outputting the multiple audio signals, the first audio signal may be output from the first audio device 200, and the second audio signal may be output from the second audio device 300. The electronic device 100 may then receive the user input for outputting the single audio signal (S1245). The single audio signal may indicate a signal for outputting only the first audio signal.

The electronic device 100 may stop the broadcasting operation of the first packet in case of receiving (or acquiring) the user input for outputting the single audio signal (S1250). In addition, the electronic device 100 may generate the first packet including only the first audio signal (S1255). The electronic device 100 may generate the first sync data corresponding to the first audio signal (S1260). The electronic device 100 may broadcast the first packet generated in operation S1255 and the first sync data generated in operation S1260 (S1265).

The first audio device 200 may receive the first packet and the first sync data broadcasted by the electronic device 100. In addition, the first audio device 200 may output the first audio signal included in the first packet (S1270).

The first packet generated in operation S1210 and the first packet generated in operation S1255 may be different from each other. The first packet described in operation S1255 may be described as the second packet because the packets are different. The first sync data generated in operation S1220 may be different from the first sync data generated in operation S1260.

According to the various embodiments, the second audio device 300 may no longer output the second audio signal.

According to the various embodiments, the second audio device 300 may receive the first packet and the first sync data broadcasted by the electronic device 100. In addition, the second audio device 300 may output the first audio signal included in the first packet.

Meanwhile, the audio signal may be interrupted based on a processing speed of the electronic device 100 and a network environment if the existing first packet is interrupted and a new first packet is generated in operation S1250. Therefore, the electronic device 100 may use an embodiment in FIG. 13 to output the audio signal without interruption.

FIG. 13 is a flowchart for describing an embodiment of receiving the user command to output the single audio signal while outputting the multiple audio signals according to various embodiments.

Operations S1305, S1315, S1320, S1325, S1330, S1335, S1340, S1345, S1360, S1365, S1370 in FIG. 13 may correspond to operations S1205, S1215, S1220, S1225, S1230, S1235, S1240, S1245, S1260, S1265, S1270 in FIG. 12. Their redundant descriptions are thus omitted.

The electronic device 100 may execute the control instruction for activating the first subgroup including the first audio signal and the second subgroup including the second audio signal in case of receiving the user input for outputting the multiple audio signals (S1311). The electronic device 100 may generate the control instruction for activating the subgroup corresponding to each of the multiple audio signals based on the user input. In addition, the electronic device 100 may control whether the subgroup is activated by executing the generated control instruction.

The electronic device 100 may generate the first packet including the activated first subgroup and the activated second subgroup (S1312). The activation information indicating whether the subgroup is activated may be included in each subgroup. In addition, the electronic device 100 may perform operations S1315 to S1340.

The electronic device 100 may execute the control instruction for activating the first subgroup including the first audio signal and for deactivating the second subgroup including the second audio signal in case of receiving the user input for outputting the single audio signal (first audio signal) (S1350). The electronic device 100 may generate the control instruction for activating the first subgroup and deactivating the second subgroup. In addition, the electronic device 100 may change whether the subgroup is activated by executing the control instruction. In detail, the electronic device 100 may change the second subgroup from the activated state to the deactivated state based on the control instruction.

The electronic device 100 may generate the first packet including the activated first subgroup (S1355). The first packet may not include the second subgroup in the deactivated state. The electronic device 100 may then perform operations S1360 to S1370.

The first packet generated in operation S1355 may have a different structure from the packet generated in operation S1312.

The first packet may be maintained as it is, and only the inclusion of the subgroup may differ in the process of changing from the operation of outputting the multiple audio signals to the operation of outputting the single audio signal. To enable the continuous broadcasting of the first packet, the electronic device 100 may maintain the existing packet structure and exclude only data for the second subgroup in the first packet.

FIG. 14 is a flowchart for describing an embodiment of receiving the user command to output the single audio signal while outputting the multiple audio signals according to various embodiments.

Referring to FIG. 14, an order of the user commands may be changed from that in the embodiment shown in FIG. 12. A redundant description thereof is omitted.

The electronic device 100 may receive the user input for outputting the single audio signal (first audio signal) (S1405). The electronic device 100 may generate the first packet including the first audio signal (S1410). The electronic device 100 may generate the first sync data corresponding to the first audio signal (S1415). The electronic device 100 may broadcast the first packet and the first sync data (S1420).

The first audio device 200 may receive the first packet and the first sync data that are broadcast. The first audio device 200 may output the first audio signal included in the first packet based on the first sync data (S1425).

The electronic device 100 may receive the user input for outputting the multiple audio signals (S1430). The electronic device 100 may stop broadcasting the first packet in case of receiving the user input for outputting the multiple audio signals while broadcasting the first packet (S1435). In addition, the electronic device 100 may perform operations S1440 to S1470.

Meanwhile, the audio signal may be interrupted based on the processing speed of the electronic device 100 and the network environment if the existing first packet is interrupted and a new first packet is generated in operation S1435. Therefore, the electronic device 100 may use an embodiment in FIG. 15 to output the audio signal without interruption.

FIG. 15 is a flowchart for describing an embodiment of receiving the user command to output the multiple audio signals while outputting the single audio signal according to various embodiments.

Operations S1505, S1515, S1520, S1525, S1530, S1545, S1550, S1555, S1560, S1565, S1570 in FIG. 15 may correspond to operations S1405, S1415, S1420, S1425, S1430, S1445, S1450, S1455, S1460, S1465, S1470 in FIG. 14.

The electronic device 100 may execute the control instruction for activating the first subgroup including the first audio signal after receiving the user input for outputting the single audio signal (first audio signal) (S1511). In addition, the electronic device 100 may generate the first packet including the activated first subgroup (S1512). In addition, the electronic device 100 may perform operations S1515 to S1525. The electronic device 100 may broadcast the first packet including only the activated first subgroup.

The electronic device 100 may execute the control instruction for activating the first subgroup including the first audio signal and the second subgroup including the second audio signal in case of receiving the user input for outputting the multiple audio signals while broadcasting the first packet (S1535). The electronic device 100 may generate the control instruction for activating the subgroup corresponding to each of the multiple audio signals based on the user input. In addition, the electronic device 100 may control whether the subgroup is activated by executing the generated control instruction.

The electronic device 100 may generate the first packet including the activated first subgroup and the activated second subgroup (S1540). The activation information indicating whether the subgroup is activated may be included in each subgroup. In addition, the electronic device 100 may perform operations S1545 to S1570.

The first packet generated in operation S1540 may have a different structure from the packet generated in operation S1512.

The first packet may be maintained as it is, and only the inclusion of the subgroup may differ in the process of changing from the operation of outputting the single audio signal to the operation of outputting the multiple audio signals. To enable the continuous broadcasting of the first packet, the electronic device 100 may maintain the existing packet structure and additionally include only the data for the second subgroup in the first packet.

FIG. 16 is a diagram for describing various control instructions.

Referring to FIG. 16, Embodiment 1610 shows an instruction related to a host controller interface (HCI).

According to the various embodiments, the HCI instruction may include at least one of text indicating an HCI relationship (HCI), text indicating Bluetooth low energy protocol (LE), text indicating the activation information of the subgroup (Enable or Disable), and text indicating a target subgroup that determines whether the target subgroup is activated (SubGroup #01).

According to the various embodiments, the HCI instruction may include at least one of text indicating an HCI relationship (HCI), text indicating Bluetooth low energy protocol (LE), text indicating the activation information of the subgroup (Enable or Disable), and text indicating a target BIS that determines whether the target subgroup is activated (BIS #01).

FIG. 17 is a diagram for describing guide audio output in an embodiment that switches from a multi-view function to a single-view function.

Referring to Embodiment 1710 in FIG. 17, the electronic device 100 may perform the multi-view function of outputting first content and second content simultaneously. The first content may include the first image signal and the first audio signal. The second content may include the second image signal and the second audio signal. The electronic device 100 may display a first image (first image signal) in the first region of the display, and a second image (second image signal) in the second region of the display.

The electronic device 100 may transmit the first audio signal synchronized with the first image signal to the first audio device 200. The first audio device 200 may output the first audio signal. In addition, the electronic device 100 may transmit the second audio signal synchronized with the second image signal to the second audio device 300. The second audio device 300 may output the second audio signal.

The electronic device 100 may broadcast the advertising packet including the first subgroup including the first audio signal and the second subgroup including the second audio signal. The first audio device 200 may output the first audio signal, and the second audio device 300 may output the second audio signal based on a predetermined instruction.

Referring to Embodiment 1720 in FIG. 17, it may be assumed that the electronic device 100 receives the user input for the single-view function (first content output) while performing the multi-view function. The electronic device 100 may display the first image (first image signal) in an entire region of the display in case of receiving the user input for the single-view function (first content output).

The electronic device 100 may transmit the first audio signal synchronized with the first image signal to the first audio device 200. The electronic device 100 may no longer transmit the second audio signal. However, the electronic device 100 may control the guide information (guide audio) to be output from the second audio device 300. The guide information may include information indicating that the second audio signal is no longer output based on the user input (single-view command).

The electronic device 100 may broadcast the advertising packet that includes the first subgroup including the first audio signal. The first audio device 200 may output the first audio signal based on the predetermined instruction.

According to the various embodiments, the second audio device 300 may no longer output the second audio signal and may output the first audio signal in case of receiving the user input for the single-view function (first content output).

If there is no separate guide audio, the user using the second audio device 300 may experience a sudden change in the audio signal. Therefore, the electronic device 100 may provide a guide UI to the device where the audio signal changes.

FIG. 18 is a flowchart for describing guide audio output in an embodiment that switches from the multi-view function to the single-view function.

Operations S1835, S1840, S1845, S1850, S1855, S1860, S1865, S1870 in FIG. 18 may correspond to operations S1335, S1340, S1345, S1350, S1355, S1360, S1365, S1370 in FIG. 13. Their redundant descriptions are thus omitted.

The electronic device 100 may execute the control instruction for activating the first subgroup including the first audio signal and the second subgroup including the guide information in case of receiving the user input for switching from the multi-view function to the single-view function (S1846-1). The electronic device 100 may change the second audio signal included in the second subgroup to the guide information. The electronic device 100 may store the guide information in the second subgroup.

The electronic device 100 may generate the first packet including the activated first subgroup and the activated second subgroup (S1846-2). The electronic device 100 may identify the first frequency band corresponding to the first subgroup and the second frequency band corresponding to the second subgroup (S1846-3). The electronic device 100 may generate the first sync data corresponding to the first audio signal (S1846-4).

The electronic device 100 may broadcast the first packet and the first sync data (S1846-5). The electronic device 100 may broadcast the first packet (S1846-6).

The first audio device 200 may output the first audio signal included in the first packet based on the first sync data (S1846-7).

The second audio device 300 may output the guide information included in the first packet (S1846-8). For example, the guide information may include the information indicating that the second audio signal is no longer output.

In addition, the electronic device 100 may repeat operations S1850 to S1870. The electronic device 100 may deactivate the second subgroup after the guide information is output. Through the guide information, the user of the second audio device 300 may be informed of the interruption of the second audio signal. Here, the user of the first audio device 200 may continuously listen to the existing first audio signal. The guide information may be output only from the second audio device 300, and the user of the first audio device 200 may continuously listen to the first audio signal without interruption.

According to the various embodiments, the second audio device 300 may output the first audio signal instead of the second audio signal.

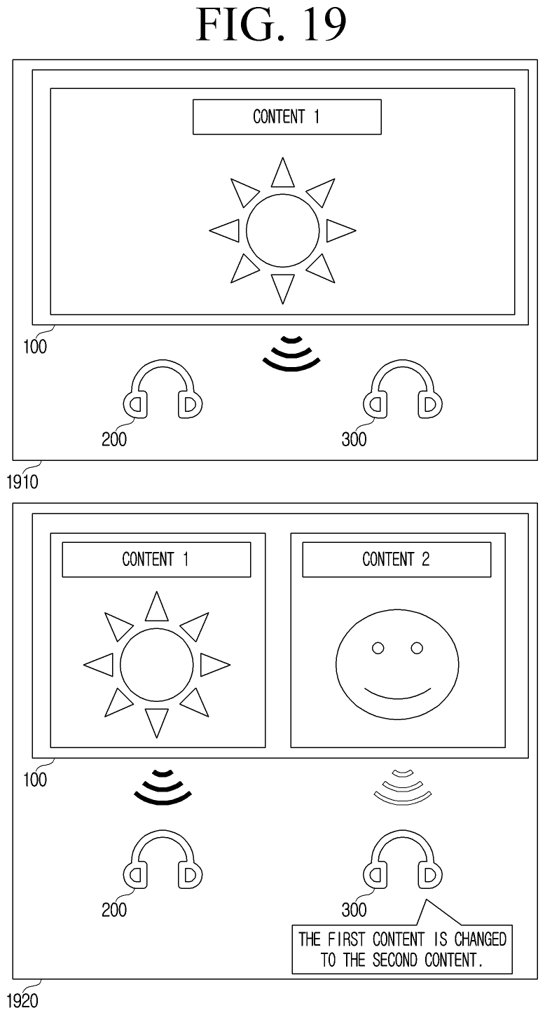

FIG. 19 is a diagram for describing guide audio output in an embodiment that switches from the single-view function to the multi-view function.

Referring to Embodiment 1910 in FIG. 19, it may be assumed that the electronic device 100 receives the user input for the single-view function (first content output). The electronic device 100 may display the first image (first image signal) in the entire region of the display in case of receiving the user input for the single-view function (first content output).

The electronic device 100 may transmit the first audio signal synchronized with the first image signal to the first audio device 200.

The electronic device 100 may broadcast the advertising packet that includes the first subgroup including the first audio signal. The first audio device 200 and the second audio device 300 may output the first audio signal based on the predetermined instruction.

Referring to Embodiment 1920 in FIG. 19, it may be assumed that the electronic device 100 receives the user input for the multi-view function while performing the single-view function (first content output). The electronic device 100 may perform the multi-view function of outputting the first content and the second content simultaneously. The first content may include the first image signal and the first audio signal. The second content may include the second image signal and the second audio signal. The electronic device 100 may display the first image (first image signal) in the first region of the display, and the second image (second image signal) in the second region of the display.

The electronic device 100 may transmit the first audio signal synchronized with the first image signal to the first audio device 200. The first audio device 200 may output the first audio signal. In addition, the electronic device 100 may transmit the second audio signal synchronized with the second image signal to the second audio device 300. The second audio device 300 may output the second audio signal.

The electronic device 100 may broadcast the advertising packet that includes the first subgroup including the first audio signal and the second subgroup including the second audio signal. The first audio device 200 may output the first audio signal, and the second audio device 300 may output the second audio signal based on a predetermined instruction.

However, the electronic device 100 may control the guide information (guide audio) to be output before the second audio signal is output from the second audio device 300. The guide information may include information indicating that the second audio signal is newly output based on the user input (multi-view command). According to the various embodiments, the guide information may include information indicating that the first audio signal is changed to the second audio signal.

FIG. 20 is a block diagram for describing guide audio output in an embodiment that switches from the single-view function to the multi-view function.

Operations S2025, S2030, S2035, S2040, S2045, S2050, S2055, S2060, S2065, S2070 in FIG. 20 may correspond to operations S1525, S1530, S1535, S1540, S1545, S1550, S1555, S1560, S1565, S1570 in FIG. 15. In addition, operations S2031-1, S2031-2, S2031-3, S2031-4, S2031-5, S2031-6, S2031-7, and S2031-8 in FIG. 20 may correspond to operations S1846-1, S1846-2, S1846-3, S1846-4, S1846-5, S1846-6, S1846-7, and S1846-8 in FIG. 18. Their redundant descriptions are thus omitted.

The electronic device 100 may output the guide information first before outputting the second audio signal based on the user command to output the multiple audio signals.

According to the various embodiments, it may be assumed that the second audio device 300 outputs the first audio signal together with operation S2025. The user of the second audio device 300 may be informed in advance a situation where the first audio signal is changed to the second audio signal through the guide information. Therefore, the user may naturally recognize the output of the second audio signal despite the sudden change.

FIG. 21 is a diagram for describing an operation of selecting a device to output each of the multiple audio signals in performing the multi-view function.

Referring to FIG. 21, the electronic device 100 may output the plurality of contents in case of receiving the user input for performing the multi-view function. It may be assumed that the plurality of contents are the first content and the second content. The first content may include the first image and first audio (first audio signal), and the second content may include the second image and second audio (second audio signal). Here, the user may select which devices output the first audio and the second audio while performing the multi-view function.

The electronic device 100 may output a guide UI 2110 for selecting which device outputs each of the multiple audio signals while performing the multi-view function.

The guide UI 2110 may include at least one of text information 2111 for requesting the selection of the device to output audio while the multi-view function is performed, a list of devices 2112 capable of outputting the first audio of the first content, or a list of devices 2113 capable of outputting the second audio of the second content.

The user may directly select the device to output the multiple audio signals through the displayed guide UI 2110.

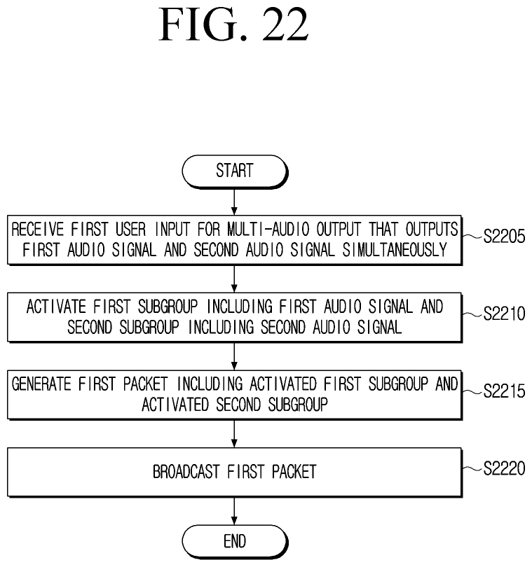

FIG. 22 is a flowchart for describing a control method for an electronic device according to various embodiments.

Referring to FIG. 22, the control method of the electronic device which is connected to the first audio device and the second audio device via the Bluetooth low energy (BLE) communication module may include: receiving the first user input for the multi-audio output that outputs the first audio signal and the second audio signal simultaneously (S2205); activating the first subgroup including the first audio signal and the second subgroup including the second audio signal (S2210); generating the first packet including the activated first subgroup and the activated second subgroup (S2215); and broadcasting the first packet (S2220), wherein the first subgroup includes the first activation information indicating that the first audio signal is available for output, and the second subgroup includes the second activation information indicating that the second audio signal is available for output.

Meanwhile, the control method may further include: deactivating the second subgroup if the second user input for the single-audio output that outputs the first audio signal is received while the first packet is broadcast; modifying the first packet to include only the activated first subgroup; and broadcasting the modified first packet.

Meanwhile, in the deactivating of the second subgroup, the instruction for deactivating the second subgroup is identified among the plurality of host controller interface (HCI) instructions stored in the electronic device, and the second subgroup is deactivated by executing the identified instruction.

Meanwhile, the first packet may include the advertising data, the advertising data may include the information on the number of subgroups, the first subgroup, and the second subgroup, each of the first subgroup and the second subgroup may include at least one of the codec ID, the codec configuration information, the metadata, or the audio signal, and the metadata may include the activation information indicating that the audio signal is available for output.

Meanwhile, the first audio signal included in the first subgroup may include the first Broadcast Isochronous Stream (BIS) representing the left audio signal and the second BIS representing a right audio signal, and the second audio signal included in the second subgroup may include the third Broadcast Isochronous Stream (BIS) representing the left audio signal and the fourth BIS representing the right audio signal.

Meanwhile, the control method may further include generating the first sync data corresponding to the first audio signal and the second sync data corresponding to the second audio signal, and broadcasting the first audio signal, the first sync data, and the second sync data together with the first packet.

Meanwhile, the control method may further include: generating the guide information if the second user input for the single-audio output that outputs the first audio signal is received while the first packet is broadcast; modifying the second subgroup to include the guide information; modifying the first packet to include the first subgroup and the modified second subgroup; and broadcasting the modified first packet.

Meanwhile, the guide information may include the information indicating that the single-audio output is performed based on the second user input.

Meanwhile, the control method may further include: identifying the first frequency band corresponding to the first audio signal and the second frequency band corresponding to the second audio signal, wherein in the generating of the first packet, the first packet including the first subgroup storing the first frequency band and the second subgroup storing the second frequency band is generated, the first frequency band being different from the second frequency band.

Meanwhile, the control method may further include: displaying the screen including the list including at least one device capable of outputting the first audio signal, the list including at least one device capable of outputting the second audio signal, and the guide information requesting selection of the device to output the audio signal if the first user input for the multi-audio output is received.

Meanwhile, the control method of an electronic device 100 as shown in FIG. 22 may be executed on the electronic device 100 having the configuration in FIG. 3 or 4, and may also be executed on the electronic device 100 having another configuration.

Meanwhile, the methods according to the various embodiments of the present disclosure described above may be implemented in the form of an application which may be installed on an existing electronic device.

In addition, the methods according to the various embodiments of the present disclosure described above may be implemented only by software upgrade or hardware upgrade of the existing display device.

In addition, the various embodiments of the present disclosure described above may be performed using an embedded server included in the electronic device, or an external server of at least one of the electronic device or the display device.

Meanwhile, according to an embodiment of the present disclosure, the various embodiments described above may be implemented in software including an instruction stored on a machine-readable storage medium (for example, a computer-readable storage medium). A machine may be a device that invokes the stored instruction from a storage medium, may be operated based on the invoked instruction, and may include the electronic device according to the disclosed embodiments. If the instruction is executed by the processor, the processor may directly perform a function corresponding to the instruction or other components may perform the function corresponding to the instruction under the control of the processor. The instruction may include codes generated or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

In addition, according to an embodiment of the present disclosure, the methods according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store (for example, PlayStore™ In case of the online distribution, at least a portion of the computer program product may be at least temporarily stored or temporarily generated on a storage medium such as the memory of a manufacturer server, an application store server, or a relay server.

In addition, each of the components (for example, modules or programs) according to the various embodiments may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. An electronic device comprising:
a memory configured to store a first audio signal and a second audio signal;
a communication interface configured to connect to a first audio device and a second audio device via a Bluetooth low energy (BLE) communication module; and
at least one processor configured to:
receive a user input for multi-audio output that outputs the first audio signal and the second audio signal simultaneously,
provide a packet that includes a first subgroup including the first audio signal and a second subgroup including the second audio signal, activated based on the received user input, and
control the communication interface to broadcast the packet,
wherein the first subgroup and the second subgroup include first and second activation information indicating that the first audio signal and the second audio signal are available for output, respectively.

2. The electronic device as claimed in claim 1, wherein the user input is a first user input, and the at least one processor is configured to:
exclude the second subgroup that is deactivated based on a second user input in case of receiving the second user input for a single-audio output that outputs the first audio signal while broadcasting the packet,
modify the packet to include only the activated first subgroup, and control the communication interface to broadcast the modified packet.

3. The electronic device as claimed in claim 2, wherein the at least one processor is configured to deactivate the second subgroup by executing an instruction corresponding to the deactivation of the second subgroup among a plurality of host controller interface (HCI) instructions stored in the memory.

4. The electronic device as claimed in claim 1, wherein the packet includes advertising data,
the advertising data includes information on a number of subgroups, the first subgroup, and the second subgroup,
the first subgroup and the second subgroup includes at least one of a codec identifier (ID), codec configuration information, metadata, or one of the first audio signal and the second audio signal, and
the metadata includes the activation information indicating that the one of the first audio signal and the second audio signal is available for output.

5. The electronic device as claimed in claim 4, wherein the first audio signal included in the first subgroup includes a first Broadcast Isochronous Stream (BIS) representing a left audio signal and a second BIS representing a right audio signal, and
the second audio signal included in the second subgroup includes a third Broadcast Isochronous Stream (BIS) representing a left audio signal and a fourth BIS representing a right audio signal.

6. The electronic device as claimed in claim 1, wherein the at least one processor is configured to
provide first sync data corresponding to the first audio signal and second sync data corresponding to the second audio signal, and
control the communication interface to broadcast the first audio signal, the first sync data, and the second sync data together with the packet.

7. The electronic device as claimed in claim 1, wherein the at least one processor is configured to:
provide guide information in case of receiving a second user input for a single-audio output that outputs the first audio signal while broadcasting the packet,
modify the second subgroup to include the guide information generated based on the second user input, and
control the communication interface to broadcast the packet modified to include the first subgroup and the modified second subgroup.

8. The electronic device as claimed in claim 7, wherein the guide information includes information indicating that the single-audio output is performed based on the second user input.

9. The electronic device as claimed in claim 1, wherein the at least one processor is configured to
identify a first frequency band corresponding to the first audio signal and a second frequency band corresponding to the second audio signal, and
provide the packet including the first subgroup storing the first frequency band and the second subgroup storing the second frequency band,
the first frequency band being different from the second frequency band.

10. The electronic device as claimed in claim 1, further comprising a display,
wherein the at least one processor is configured to control the display to display a screen including a list including at least one device available to output the first audio signal, a list including at least one device available to output the second audio signal, and guide information requesting selection of a device to output one of the first audio signal and the second audio signal in case of receiving the user input for the multi-audio output.

11. A control method for an electronic device which is connected to a first audio device and a second audio device via a Bluetooth low energy (BLE) communication module, the control method comprising:
receiving a first user input for multi-audio output that outputs a first audio signal and a second audio signal simultaneously;
providing a packet that includes a first subgroup including the first audio signal and a second subgroup including the second audio signal, activated based on the received first user input; and
broadcasting the packet,
wherein the first subgroup and the second subgroup include first and second activation information indicating that the first audio signal and second audio signal are available for output, respectively.

12. The control method as claimed in claim 11, wherein the user input is a first user input and the control method further comprising:
excluding the second subgroup that is deactivated based on a second user input provided the second user input for a single-audio output that outputs the first audio signal is received while the packet is broadcast;
modifying the packet to include only the activated first subgroup; and
broadcasting the modified packet.

13. The control method as claimed in claim 12, wherein in the deactivating of the second subgroup,
the second subgroup is deactivated by executing an instruction corresponding to the deactivation of the second subgroup among a plurality of host controller interface (HCI) instructions stored in the electronic device.

14. The control method as claimed in claim 11, wherein the packet includes advertising data,
the advertising data includes information on a number of subgroups, the first subgroup, and the second subgroup,
each of the first subgroup and the second subgroup includes at least one of a codec identifier (ID), codec configuration information, metadata, or one of the first audio signal and the second audio signal, and
the metadata includes the activation information indicating that the audio signal is available for output.

15. The control method as claimed in claim 14, wherein the first audio signal included in the first subgroup includes a first Broadcast Isochronous Stream (BIS) representing a left audio signal and a second BIS representing a right audio signal, and
the second audio signal included in the second subgroup includes a third Broadcast Isochronous Stream (BIS) representing a left audio signal and a fourth BIS representing a right audio signal.
